(19) United States
(12) Patent Application Publication
(10) Pub. No.: US 2010/0187771 A1
(43) Pub. Date: Jul. 29, 2010

(54) THREE- DIMENSIONNAL FLAT GASKET

(76) Inventors: Hans-Dieter Dieter Waltenberg, Neu- Ulm (DE); Kurt Hoehe, Langenau (DE); Bernd Ruess, Voehringen (DE)

Correspondence Address: MARSHALL & MELHORN, LLC, FOUR SEAGATE, 8TH FLOOR, TOLEDO, OH, 43804, US

(21) Appl. No.: 12/451,017

(22) PCT Filed: Apr. 24, 2008
(86) PCT No.: PCT/EP2008/003315

§ 371 Date: Mar. 16, 2010

(30) Foreign Application Priority Data
Apr. 24, 2007 (DE) 10 2007 019 330.2

(51) Int. Cl. F02F 11/00; F16J 15/08; F01N 13/00; F16J 15/12

(52) U.S. Cl. 277/595; 277/596

(57) ABSTRACT

The present invention relates to a gasket (1) which is suitable for the seal between two components. Gaskets (1) of this type are used for example in engine construction in order to seal all types of pipes and other connections in the exhaust pipes. According to the invention, this gasket (1) has at least one non-even gasket layer (2) which surrounds a through-opening (6) which is to be sealed. In this gasket layer (2) there is situated at least one periodic structure (12) with a period length greater than 1 which surrounds the through-opening (6) at least in regions. This periodic structure (12) is embossed in the gasket layer (2) in such a manner that the total thickness of the gasket layer (2) in the region of the periodic structure (12) is greater than the material thickness of the gasket layer (2).

The present invention relates to a gasket which is suitable for the seal between two components. Gaskets of this type are used for example in engine construction in order to seal e.g. cylinder head relative to inlet or outlet manifolds, however in particular in order to seal pipes and other connections in the exhaust pipes including the exhaust gas recirculation and also in the region of the charging.

Components of this type often do not have planar (even) surfaces between which a seal is intended to be provided. Rather, the surfaces to be sealed are often formed three-dimensionally, for example conically curved. The present invention now relates to gaskets for sealing surfaces of this type. Adapted to the surfaces to be sealed, gaskets of this type therefore have flat, but not even, gasket layers. This means that the individual gasket layer in fact has a flat dimension, i.e. the thickness of the gasket layer is significantly smaller than its longitudinal and transverse dimension but the gasket layer is formed such that the surface of the gasket layer no longer extends essentially in one plane.

An example of a gasket of this type is a pipe flange gasket which is normal in engine construction and surrounds an opening forming a seal in a conical form. Like many gaskets in engine construction, a pipe flange gasket also often has a bead which extends in the surface of the gasket layer and surrounds an opening to be sealed. Conventionally, in this field of gasket construction, no stopper is disposed adjacent to the sealing bead because of the constructional conditions of a three-dimensionally formed, flat gasket layer. If a stopper is used, then normally a crimped-over stopper or a welded-on ring is used as such, said ring making available the required material thickness of the stopper.

It is disadvantageous in this state of the art that either the gaskets without stoppers have unfavourable sealing properties or a stopper can be integrated into the gasket only with great complexity, in particular with additional material expenditure or additional operating processes.

It is therefore the object of the present invention to produce a gasket for the seal between non-even surfaces of two components, which has a flat, but not even, i.e. a three-dimensionally formed gasket layer, this being intended to be provided in addition to a structure which can be introduced into the gasket economically.

This object is achieved by the gasket according to claim 1 and the use thereof according to claim 36.

Advantageous developments of the gasket according to the invention are provided in the respective dependent claims.

The gasket has according to the invention at least one flat, but not even, gasket layer. The gasket layer is then termed as flat as long as the longitudinal and transverse dimension thereof is significantly greater than the thickness thereof, for example, in one direction, by a factor of 5, advantageously more than 10 times, longer than thick. This gasket layer is formed three-dimensionally in the present invention, i.e. not even. This means that the surface dimension of the gasket layer does not extend essentially in a single plane, i.e. for example disregarding local embossings in the gasket layer, but rather the gasket layer can have for example two regions which are angled at an angle relative to each other. On the other hand, it can also have a conical or spherical form so that the gasket layer forms the outer peripheral face of a truncated cone.

In order to achieve good elastic sealing properties of the gasket layer, the gasket layer contains or comprises essentially steel, in particular cold-rolled steel, spring steel, stainless steel, temperature-stable steel. For example nickel-rich steel or carbon-rich steel is used. Also a cold-workable steel which can be hardened by means of temperature treatment is suitable for the gasket layer according to the invention.

As is known from the state of the art, the surfaces of the gasket layer can thereby be coated partially or completely. One- or two-sided coatings are thereby possible. According to the application case, coatings are used for micro-sealing, for friction reduction, anti-corrosion coatings or even metallic coverings for improving the heat resistance—if necessary also in combination. A coating can also be used partially or a spatial combination of different coatings to provide regions with different electrical or thermal conductivity. The gasket according to the invention can be made from pre-coated material or be coated completely or in areas after the structures have been embossed.

The gasket according to the invention has at least one through-opening which in the installed state is aligned with the openings to be sealed by the gasket. A periodic structure which is embossed in the gasket layer and has at least one period surrounds the through-opening at least in regions in at least one of the above-described gasket layers. This periodic structure is embossed in the gasket layer in such a manner that the total thickness of the gasket layer in the region of the periodic structure is greater than the material thickness of the gasket layer itself. This means that a sealing and/or stopper structure is produced around the through-opening by means of the periodic structure.

This periodic structure can be configured for example in the form of a profiling which is undulating, approximately perpendicular to the circumferential direction of the through-opening and surrounds the through-opening. This undulating profiling can have in particular a sinusoidal cross-section. It is also possible that the undulating profiling has a trapezoidal cross-section. Likewise, intermediate forms between sinusoidal and trapezoidal are possible.

The undulating periodic structure may be designed in such a way that when considering the cross section between the outer edge of the gasket and the trough opening at an arbitrarily chosen region of the through opening, the crests on one of the surfaces are arranged in such a way that they define a straight line. The same is true for the troughs on one of the surfaces as well as for the structures on the respective other surface. It is however also possible to design the undulating structure in such a way that a comparable cross section reveals the crests on one of the surfaces on an arcuate line. It is preferred that this arc is regular, but there are applications feasible in which a non-regular, e.g. non-symmetric arc is preferred. In the latter two embodiments, the undulating structure may also be considered as being superposed by a curved structure. Such a structure allows an optimal balance of resiliency and stiffness of the sealing element.

In the case of such an undulating periodic structure, the respective wave crests or wave troughs can also be flattened or levelled, as a result of which a particularly effective support surface of the structure on the adjacent surfaces to be sealed is configured. Furthermore, the heights of the wave crests, i.e. the amplitude, are not strictly constant over the entire profiling but, in specific circumferential regions around the through-opening, can have different heights taking into account the respective geometric form of the components to be sealed. In the same way, also the spacings of the wave crests can be varied relative to each other. A variation is thereby possible within the profiling in the manner perpendicular to the circumferential direction and also longitudinally to the circumferential direction.

Also the number of undulations, which are in succession perpendicular to the circumferential direction and are part of the profiling, can be different in different circumferential regions of the through-opening. Also the profile heights and/or the spacings of the wave crests of the profiling, viewed in the direction perpendicular to the circumferential direction of the through-opening, can be of different sizes in different circumferential regions around the through-opening. As a result of a different configuration and dimensioning of this type, the undulating profiling can be adapted to any conceivable requirement in that the elasticity, the resilient rigidity or also a specific desired degree of plastic deformation is adjusted individually in the different regions of the profiling along the circumferential direction of the through-opening.

Densified regions of the profiling thereby have less elasticity and can be deformed plastically only in a limited fashion. As a result, the stopper can be stiffened. In total, it is consequently possible to achieve an individual, adequate and durable sealing effect of the gasket according to the invention by corresponding configuration of the profiling both perpendicular to the circumferential direction of the through-opening and along the circumferential direction of the through-opening. Not least, it is also possible in an advantageous manner to configure differently the wave crests/troughs of an undulating periodic structure, which are disposed on different sides of the gasket layer, with respect to their form, for example the height thereof, the spacing between individual wave crests or wave troughs, their geometric form and/or material thickness thereof and the like. As a result, the sealing function and the stopper function can be coordinated on both sides of the gasket layer individually to the respective adjacent surface to be sealed.

The elasticity and resilient stiffness of the individual undulations of such an undulating periodic profiling can in addition be varied in that the profiling is upset in the region of the crests and/or troughs so that the crest and/or troughs, in comparison to the side of the respective undulation, have a material tapering. In another manner, the side of an undulation can also be upset so that, in comparison to the wave crests and/or troughs, it has a tapering with respect to the material thickness thereof. The thickness can thereby be measured perpendicular to the material surface in the region of the side and perpendicular to the material surface in the region of the crests or troughs.

In particular, for forming a stopper which is intended to have a relatively high resilient stiffness, it is possible to provide a side tapering. As a result, even if the height of the stopper undulation is smaller than the height of an adjacent sealing bead, a sufficiently great lack of elasticity is achieved in order that the stopper undulation can also act as stopper for the higher sealing bead. The same applies if the sealing bead is replaced with two adjacent beads situated one upon the other with their crests in different gasket layers, where the individual beads may have a height smaller than the stopper undulation.

The periodic structure according to the invention is outstandingly suitable for adapting the gasket to the geometric conditions and for example also to the forces occurring there and for supporting the gasket on these components. In addition, it can take over the sealing function itself or represent, as stopper, a stopper for an adjacent sealing structure, for example a bead which surrounds the through-opening. A periodic structure of this type can be adapted topographically to the form of the components to be sealed.

In addition to the described undulation as periodic sealing structure which has an undulating cross-section perpendicular to the circumferential direction of the through-opening, also further structural forms can be used advantageously. The same applies if a sealing bead is replaced by two or more adjacent beads which are situated one upon the other in particular with their heads in different sealing layers.

Structures of this type are described in particular in claims 2 to 10. In sections through the gasket layer perpendicular to the surface of the gasket layer and parallel or perpendicular to the circumferential direction of the through-opening they have discrete raised portions and depressions which are in succession adjacently. Viewed in section, raised portions on one surface are thereby situated directly opposite depressions on the opposite surface. The raised portions or depressions can have a U-shaped cross-section. They are produced for example if, along the circumferential direction of the through-opening, a structure which meanders transversely relative to the circumferential direction is embossed in the gasket layer. Alternatively, a structure can also be configured in which, perpendicular to the circumferential direction of the through-opening, a large number of beads extend approximately parallel to each other over a specific length. A further possibility for periodic structures which can be used here are chess board-like or honeycomb, regular patterns of knobs, the caps of which are advantageously flattened and configured approximately parallel to the surface direction of the gasket layer.

A pattern similar to the chess board-like pattern is produced if the respective raised portions and/or depressions of a structure which has an undulating configuration comprising bead-like raised portions and depressions which extend concentrically relative to each other and to the through-opening are connected to each other via webs. As a function of the spacing of the webs, a chess board-like pattern is then also produced here.

It is particularly advantageous if, in a plan view on the gasket layer, the surface taken up in total by the raised portions is at least half of the total surface of the periodic structure. Advantageously, the surface taken up in total by the raised portions is significantly greater than 50% of the total surface. The surface taken up by a raised portion is defined as the surface of all those regions of the gasket layer which were formed during production of the raised portion by forming the gasket layer, i.e. protrude from the plane which is defined by the gasket layer without the formations or before the formation.

Advantageously, the raised portions and depressions are in succession in the circumferential direction of the through-opening, in a plan view on a surface of the gasket layer. This is the case for example with the above-described meandering or also in the case of chess board-like or honeycomb regular structures.

If the gasket layer is viewed in sections which are effected along the circumferential direction of the through-opening and perpendicular to the surface of the gasket layer, these structures, with the cups of the raised portions which are pressed against adjacent sealing surfaces, form contact zones which surround the through-opening in the circumferential direction at least in regions or also completely, are connected to each other completely at least in regions or also connected to each other completely but are interrupted periodically longitudinally to the circumferential direction of the through-opening. A configuration of contact zones of this type, as are produced for example by the above-indicated meandering, chess board-like or honeycomb patterns, makes it possible to provide sealing elements or stoppers in those regions of the gasket according to the invention where these are actually required.

In total, the result for the gasket according to the invention is that a particularly economical manufacturing process can be implemented for it since it is not required to apply for example a stopper on the gasket by means of a further manufacturing step (welding-on of a ring or crimping over). Rather, it is now possible to emboss the periodic structure in a still even, flat metal sheet which is intended subsequently to become the gasket layer, thereafter to reshape this metal sheet into the 3D form and if necessary to emboss with this shaping at the same time or subsequently in particular a sealing structure, such as for example to introduce a bead into the metal sheet. A different combination or sequence of the three mentioned formation processes, embossing the profile, embossing the bead and three-dimensional forming is likewise conceivable. A combination of all three steps in one operating stroke is likewise possible. Following the reshaping and embossing of the bead, the gasket is stamped out of the metal sheet. In this way, neither an additional material nor an additional operating process in required in order to introduce a bead with stopper into a three-dimensionally formed gasket of this type. The finished gasket comes finished out of the tool. Alternatively, other manufacturing sequences are also conceivable.

Neither the through-opening nor the outer contour of the gasket itself require necessarily to be rotationally symmetrical or even circular. The gasket can also have oval or other forms.

The periodic structure also need not necessarily surround the through-opening completely. However, it is advantageous possibly to allow the periodic structure to surround the through-opening completely.

The gasket according to the invention can also have a plurality of gasket layers which, in a corresponding manner to that described above, likewise have periodic structures. The periodic structures can thereby differ for example in their profile height, the spacing of the wave crests or in their radii of curvature.

The gasket layer in the case of the gasket according to the invention is configured as a non-even gasket layer. Such a non-even gasket layer can be present for example in the form of a conical gasket layer.

In addition to a conical region, in general a non-even region, the gasket layer can have a further even region. An even region is present when this region—as described already above—extends essentially in a single plane, for example in a plane which is defined by the central axis of the through-opening as normal. This can abut against the conical or in general non-even region both orientated towards the through-opening or even orientated towards the outside of the gasket layer. Also further configurations which have both even and non-even regions are possible.

The gasket is configured particularly advantageously if it has, on the one hand, a bead which surrounds the through-opening, for example a full bead or half bead, and a periodic structure according to the invention is disposed as stopper adjacent to the bead in the same gasket layer or in an adjacent gasket layer. The bead and the stopper can be disposed, viewed from the through-opening, in any sequence one behind the other. It is also not required that the periodic structure is adjacent, as stopper, to the bead on its entire circumference. It suffices to dispose the stopper in portions, e.g. also on projections of the gasket layer provided for this purpose.

As a function of the three-dimensional form of the gasket according to the invention, bead and stopper according to the invention can be disposed also in different regions of the three-dimensional form of the gasket. For example, it is possible to dispose the bead in a first even region whilst the stopper is disposed in a second region which, for its part, is in fact even but extends at an angle relative to the first even region. An arrangement of the bead and stopper is also possible in the same region, i.e. on one side adjacent to the angling-over.

The gasket according to the invention is suitable in particular for sealing pipe connections of two pipes which are connected to each other. In particular, it can be used in order to connect pipes with conical or spherical ends to each other in a sealing manner for corresponding engagement of one in the other. Pipe connections of this type occur in particular in the exhaust pipes of internal combustion engines. However, the present gasket according to the invention can also be used in all further areas in which pipe connections occur or surfaces require to be sealed relative to each other.

In the following a few examples of gaskets according to the invention are now given. The examples depicted are only of exemplary character and the invention is not restricted to them. The same and similar reference numbers thereby describe the same and similar elements in all the Figures.

There are shown

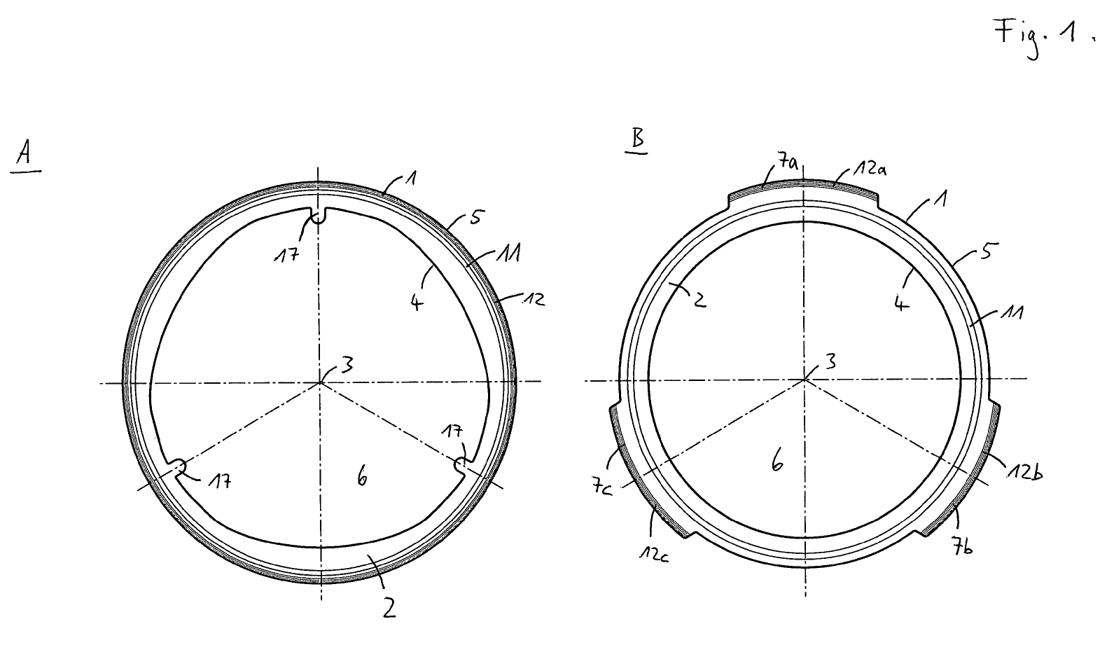

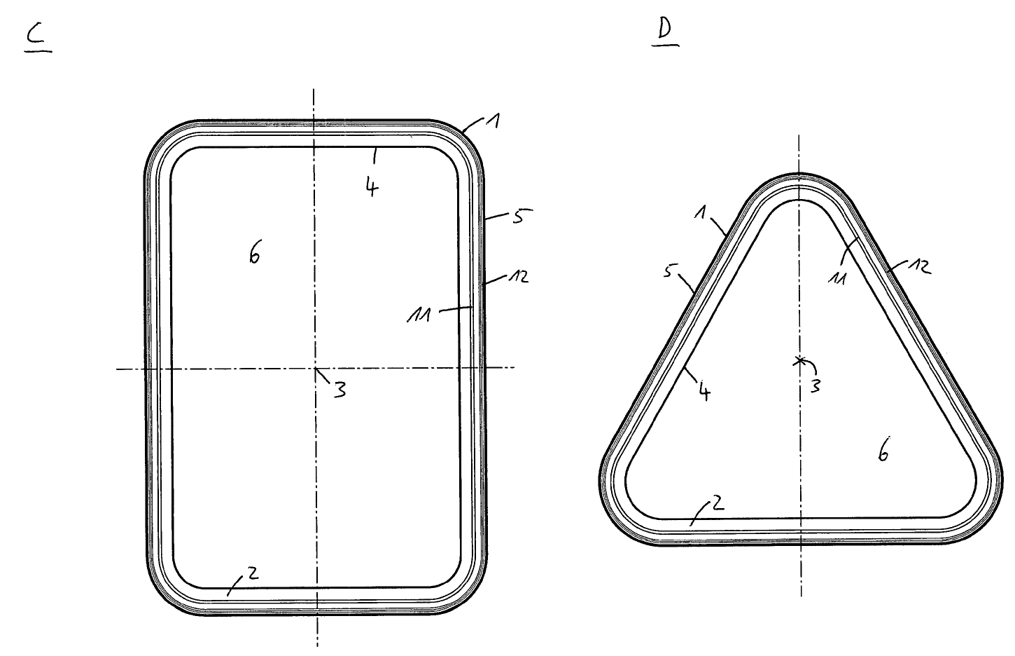

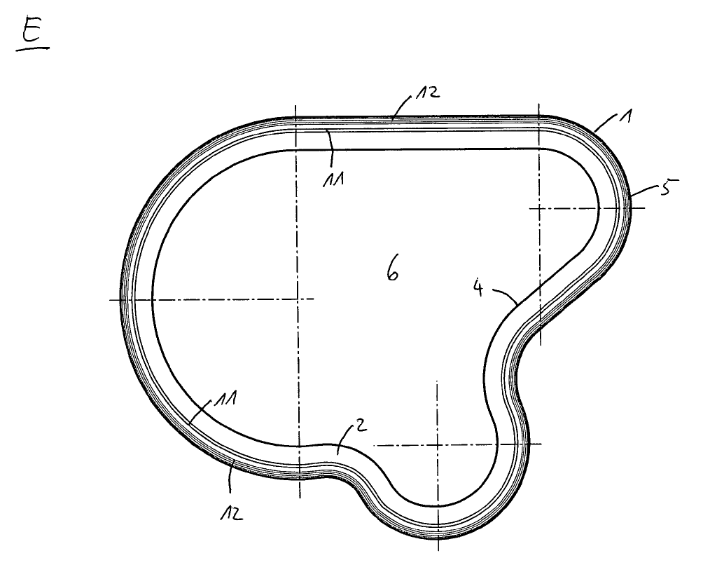

FIG. 1 five different gaskets according to the invention in plan view;

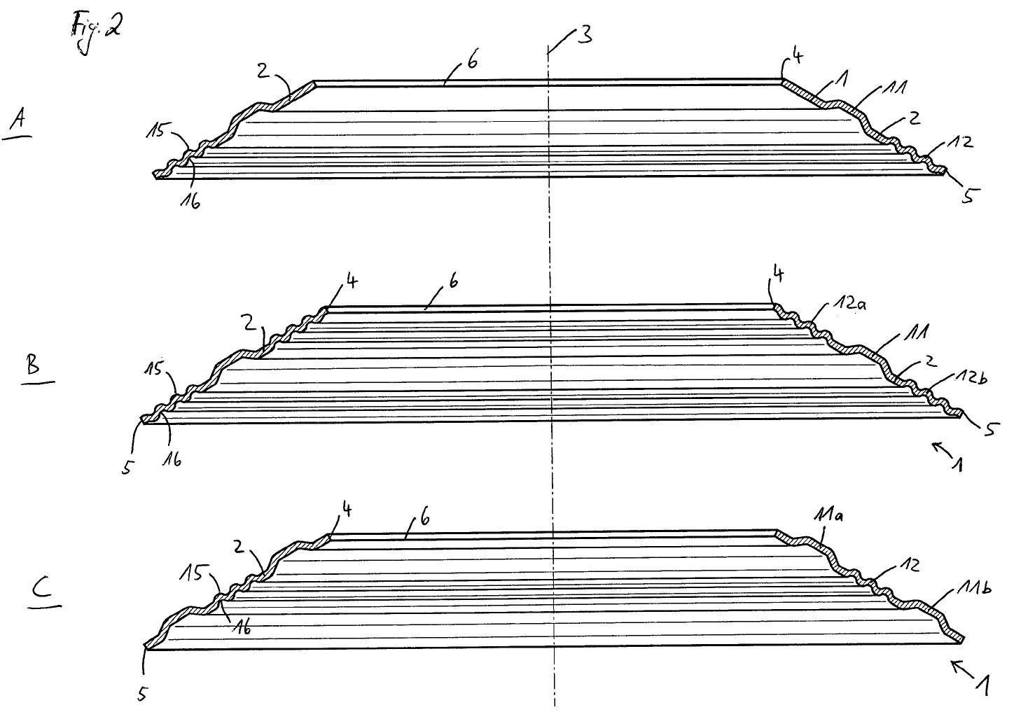

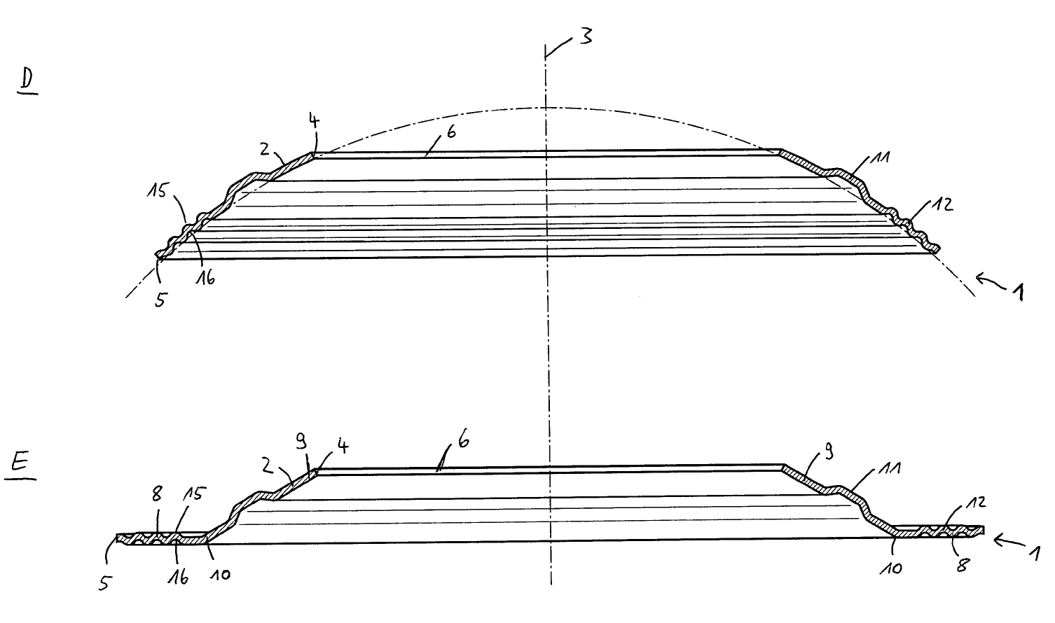

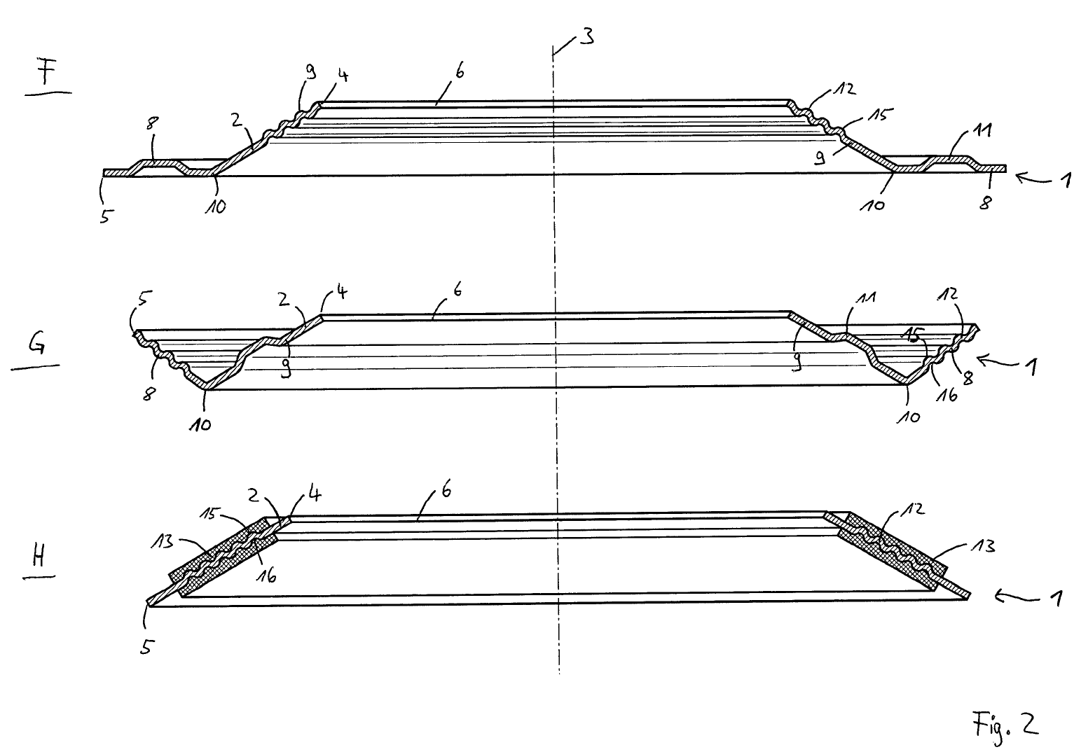

FIG. 2 nine different gaskets according to the invention in cross-section; and

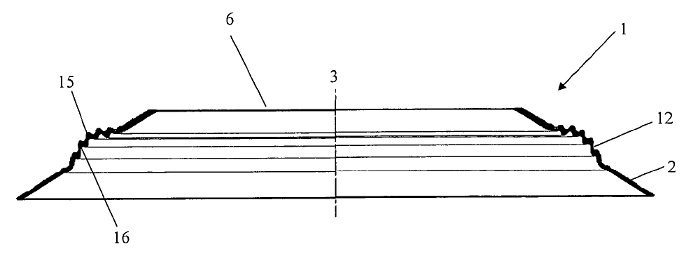

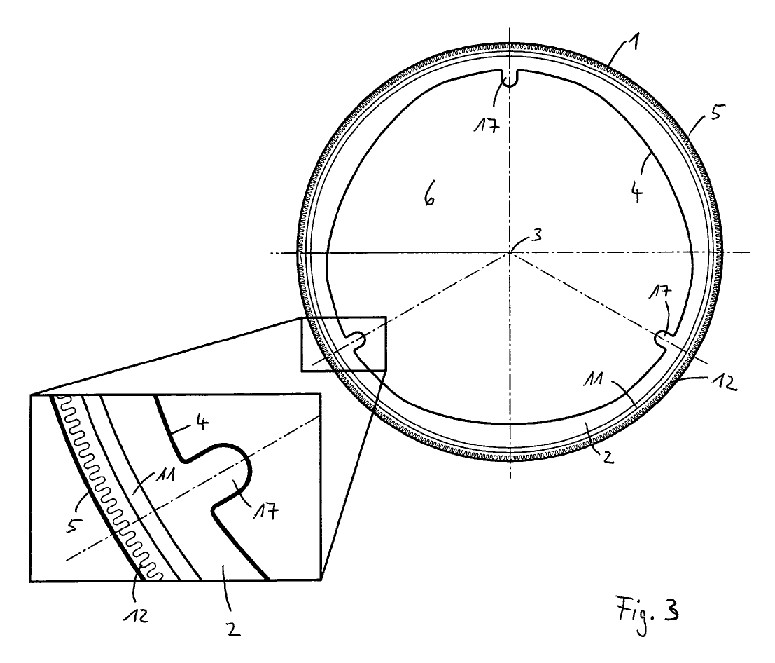

FIG. 3 a further gasket according to the invention.

FIG. 1 shows, in the partial pictures A to E, different gaskets 1, which comprise at least the gasket layer 2 shown here. The gasket layer 2 thereby surrounds, in Figures A, B, C and D, a central axis 3 symmetrically. The gasket layer 2 is punched out of a metal sheet and has an opening 6 as through-opening for example for an exhaust pipe, a combustion chamber, a liquid or the like. The layer 2, on the side orientated towards the opening 6, has an inner edge 4 and an outer edge 5 on the side orientated away. The layer 2, at its inner edge 4, has otherwise known tabs 17 which serve as centring devices.

In FIG. 1B, projections 7a to 7c at which the circumferential diameter of the gasket layer 2 is enlarged at the outer edge 5 are represented.

All of the gaskets represented in FIG. 1 have a sealing bead 11 which surrounds the through-opening 6 and seals the latter. Adjacent to the bead 11, a periodic structure 12 is disposed which acts as stopper for the sealing bead 11. In FIG. 1A, the periodic structure 12 is also completely circumferential just as in FIGS. 1C, 1D and 1E. In FIG. 1B, the periodic structure 12 extends in individual portions 12a, 12b, 12c in the projections 7a, 7b or 7c and hence surrounds the sealing bead 11 incompletely.

The periodic structure 12 in the examples of gaskets 1 represented in FIG. 1 is represented as a periodic undulating profiling which, in cross-section perpendicular to the circumferential direction of the through-opening 6 and of the bead 11, has an undulating, in particular sinusoidal, structure. The height of the individual undulations in the periodic structure 12 is thereby lower than the sum of the heights of the sealing beads in the sealing layers which form the primary sealing line.

In FIG. 1, five different forms, in particular round, square, triangular and freely formed shapes of a gasket according to the invention are represented.

FIG. 2 now shows in total nine cross-sections through different gaskets according to the invention. The gaskets can be coated or not coated according to the application, a representation in this respect in the Figures has been dispensed with for the sake of clarity. They have an essentially conical three-dimensional, i.e. non-even, form. It can be detected in cross-section that, in FIGS. 2A to 2G, an undulating stopper 12 is assigned respectively to one sealing bead 11. This undulating stopper 12 has raised portions 15 in periodic sequence, to which corresponding recesses 16 which are situated directly opposite on the opposite surface are assigned. Both the raised portions 15 and the depressions 16 are produced by embossing of the periodic structure 12 in the same operating process.

In FIGS. 2A to 2C, the gasket layer 2 can be detected as a metal sheet which is provided with beads and stoppers, embossed and shaped into a conical form. The undulating stopper can for instance be disposed on the outside of the bead 11 as in FIG. 2A, on both sides of the bead 11 as stopper 12A and stopper 12B as in FIG. 2B, or in the centre between two beads 11a and 11B a stopper 12 as in FIG. 2C.

In FIG. 2D, the form of the gasket layer 2 is not only conical but also, for its part, curved in itself so that it extends on a spherical portion, i.e. is configured in addition spherically.

In FIG. 2E and 2F and also FIG. 2G, the gasket layer 2 is subdivided into two portions 8, 9 which are angled at a predetermined angle at a bending position 10. In FIG. 2E, the gasket layer has a first outer flat and even portion 8, whilst the inner portion 9 is configured as a conical portion 9 angled at an angle at the bending position 10 relative to the first portion 8. In FIG. 2E, the sealing bead 11 is configured in the conical second inner portion 9, whilst the stopper is embossed in the outer flat and even portion 8. In FIG. 2F, a gasket is represented as in FIG. 2E, the bead 11 now being disposed however in the outer portion 8. The inner portion 9 now carries the undulating stopper 12.

In FIG. 2G, both the outer and the inner portion which are angled relative to each other at a predetermined angle at the bending position 10 have a conical configuration, the outer portion 8 representing an upwardly open cone envelope and the portion 9 a downwardly open cone envelope. Here also, the bead is disposed in the inner portion 9, whilst the undulating profiling is embossed in the outer portion 8.

FIG. 2H shows a gasket as in FIG. 2A, the latter having however no bead but merely an undulating profiling for the seal. This undulating profiling, as the preceding examples of FIGS. 2A to 2G, has raised portions 15 and corresponding depressions 16 situated directly opposite them. On both sides of the gasket layer 2, an elastomer 13 is applied over the entire profiling as an additional sealing element.

FIG. 2I shows a further embodiment of the invention on the example of a gasket 1 with conical basic shape as in the examples of FIG. 2A to 2C. The periodic structure 12 compared to these examples is however modified in such a way that the raised portions on one surface of the gasket do not define a straight line, as was the case in FIGS. 2A to 2C but an arcuate shape. The gasket shown in FIG. 2I moreover is designed without an additional bead next to the periodic structure, which is however not mandatory.

FIG. 3 now shows a further example of a gasket as was already represented in FIG. 1A. In contrast to this gasket, the detail enlargement now shows that a periodic profiling 12 is disposed on the outer edge 5 adjacent to the bead 11 and is configured as a meandering bead. This meandering bead has, in cross-section along the circumferential edge of the opening 6, a knob-like structure with raised portions and depressions. This periodic structure serves as stopper for the bead 11 which forms the actual sealing line which surrounds the opening 6.

1-38. (canceled)

39. A gasket for the seal between two components with at least one flat, but not even, gasket layer made of steel, the gasket layer having a through-opening which is to be sealed and surrounding said through-opening, wherein, in the non-even gasket layer, at least one periodic structure with a period length greater than 1 which surrounds the through-opening at least in regions is embossed in such a manner that the total thickness of the gasket layer in the region of the periodic structure is greater than the material thickness of the gasket layer.

40. The gasket according to claim 39, wherein the periodic structure in the gasket layer is formed by such a forming of the gasket layer that, in sections through the gasket layer perpendicular to the surface of the gasket layer, the gasket layer has raised portions which are parallel or perpendicular to the circumferential direction of the opening, are discrete and are in succession and adjacent to each other and corresponding recesses which are situated directly opposite said raised portions in the gasket layer.

41. The gasket according to claim 39, wherein, in a plan view on the gasket layer, the surface taken up in total by the raised portions is at least half of the total surface of the periodic structure.

42. The gasket according to claim 40, wherein, viewed from one surface of the gasket, the raised portions and depressions are in succession in the circumferential direction of the through-opening.

43. The gasket according to claim 40, wherein, in sections through the gasket layer, along the circumferential direction of the opening and perpendicular to the surface of the gasket layer, the cups of the raised portions which are to be pressed in the installed gasket against an adjacent sealing surface form with this sealing surface a contact zone which surrounds the through-opening in the circumferential direction at least in regions, is connected at least in regions but is interrupted periodically longitudinally to the circumferential direction of the through-opening.

44. The gasket according to claim 40, wherein, in sections through the gasket layer, along the circumferential direction of the through-opening and perpendicular to the surface of the gasket layer, the raised portions have an approximately U-shaped cross-section.

45. The gasket according to claim 40, wherein the raised portions have a knob-shaped configuration.

46. The gasket according to claim 40, wherein, in a plan view on the gasket layer, the raised portions form a honeycomb pattern or a chess board-like pattern.

47. The gasket according to claim 40, wherein adjacent raised portions are formed by at least one bead which surrounds the through-opening at least in regions in a plan view on the gasket layer and, over at least a part of its length, forms a meander which extends in the circumferential direction of the through-opening and meanders transversely relative thereto.

48. The gasket according to claim 40, wherein, in a plan view on the gasket layer, the raised portions are formed by at least one crown or crown portion which surrounds the through-opening at least in regions and comprises beads which extend approximately in the radial direction with respect to the circumferential edge of the through-opening.

49. The gasket according to claim 39, wherein the periodic structure is configured at least in regions in the form of an undulating profiling around the through-opening approximately perpendicular to the circumferential direction.

50. The gasket according to claim 49, wherein the crests of the raised portions of the periodic structure in a particular region perpendicular to the circumferential direction define a straight line.

51. The gasket according to claim 49, wherein the crests of the raised portions or the periodic structure in a particular region perpendicular to the circumferential direction define an arcuate shape.

52. The gasket according to claim 39, wherein, adjacent to the gasket layer in which the profiling is configured, there is a further layer which is profiled correspondingly with the same or a different profile height (amplitude) and/or spacing of the wave crests (period length) and/or radii of curvature.

53. The gasket according to claim 49, wherein the profile height (amplitude) and/or the spacings of the wave crests within the profiling are different approximately perpendicular to the circumferential direction.

54. The gasket according to one of the claim 49, wherein the wave crests and/or troughs are flattened or levelled at least in portions.

55. The gasket according to claim 49, wherein, approximately perpendicular to the circumferential direction, the number of undulations in different circumferential regions around the through-opening is different.

56. The gasket according to claim 49, wherein, approximately perpendicular to the circumferential direction, the profile heights and/or the spacings of the wave crests of the profiling in different circumferential regions around the through-openings are of different sizes.

57. The gasket according to claim 49, wherein webs are present in wave troughs of the profiling.

58. The gasket according to claim 49, wherein the wave crests/troughs disposed on different sides of the gasket layer have a different shaping, for example height, spacing, form and the like, and/or material thickness.

59. The gasket according to claim 53, wherein the profiling is sinusoidal or trapezoidal.

60. The gasket according to claim 49, wherein the profiling is upset in the form of an undulation in the region of the side so that, in comparison to the wave crests and/or troughs, a tapering is present.

61. The gasket according to claim 49, wherein the profiling is upset in the form of an undulation in the region of the crests and/or troughs so that, in comparison to the flange (side), a tapering is present.

62. The gasket according to claim 49, wherein, within the profiling, a filling material, for example an elastomer, is contained at least partially and/or in regions.

63. The gasket according to claim 39, wherein at least the gasket layer in which the profiling is configured contains or comprises cold-rolled steel, spring steel, stainless steel, temperature-stable steel, in particular Ni-rich steel and/or C-steel.

64. The gasket according to claim 39, wherein at least the gasket layer in which the profiling is configured contains or comprises a cold-workable steel which can be hardened by means of temperature treatment.

65. The gasket according to claim 39, wherein the through-opening in the gasket layer has a circular, round, oval, triangular, polygonal or freely formed configuration.

66. The gasket according to claim 39, wherein, in the gasket layer in which the periodic structure is configured and/or in a gasket layer adjacent thereto surrounding the through-opening, along the extension at least of one of the periodic structures and adjacent to the at least one periodic structure, at least one bead which forms a sealing line is configured and the at least one periodic structure which is disposed at least on one side adjacent to the at least one bead forms a stopper for at least one of the at least one bead.

67. The gasket according to claim 66, wherein the total height of the beads for which the periodic structure forms a stopper is greater than the height of the periodic structure.

68. The gasket according to claim 39, wherein the at least one bead runs round between the through-opening and at least one of the stoppers or the stopper is disposed between the through-opening and the at least one bead.

69. The gasket according to claim 66, wherein at least one of the at least one beads is a full bead or a half bead.

70. The gasket according to claim 39, wherein the gasket layer has a conical or spherical form surrounding the through-opening.

71. The gasket according to claim 39, wherein the gasket layer, in the radial direction around the through-opening, has at least one bending position, a bead which is possibly present and forms a sealing line being disposed on the same or on the other side of the bending position as the profiling.

72. The gasket according to claim 39, wherein the gasket layer has a radially inner first conical or spherical region adjacent to the through-opening and a radially outer second even region adjacent to the outer edge of the gasket layer.

73. The gasket according to claim 39, wherein the gasket layer has a radially inner first even region adjacent to the through-opening and a radially outer second conical or spherical region adjacent to the outer edge of the gasket layer, the opening angles of both regions being different relative to the central axis of the gasket.

74. The gasket according to claim 39, wherein the gasket layer has a radially inner first conical or spherical region adjacent to the through-opening and a radially outer second conical or spherical region adjacent to the outer edge of the gasket layer, the opening angles of both conical or spherical regions being different.

75. The gasket according to claim 39, wherein the gasket layer is coated at least in portions on at least one of its surfaces.

76. The gasket according to claim 39, wherein the gasket seals a pipe connection of two pipes connected to each other, in particular pipes with conical or spherical ends for corresponding engagement one in the other, in particular of exhaust pipes of internal combustion engines.
